(19) United States
(12) Patent Application Publication
(10) Pub. No.: US 2002/0176658 A1
(43) Pub. Date: Nov. 28, 2002

(54) Re-configurable wavelength and dispersion selective device

(76) Inventor: John Prohaska, Millbury, MA (US)

Correspondence Address: Marc Kaufman, Esquire, Nixon Peabody LLP, Suite 800, 8180 Greensboro Drive, McLean, VA, 22102, US

(21) Appl. No.: 09/976,290

(22) Filed: Oct. 15, 2001

Related U.S. Application Data
(60) Provisional application No. 60/239,882, filed on Oct. 13, 2000.

(51) Int. Cl. G02B 6/293; G02B 6/35

(52) U.S. Cl. 385/24; 385/18

(57) ABSTRACT

A re-configurable wavelength selective device, also referred to as a reconfigurable wavelength drop device, has an input fiber, where a signal comprising multiple wavelengths λ₁, λ₂ . . . λₙ is brought into the device, and two output fibers, one for a selected wavelength λ₁ and the other for the remaining wavelengths λ₁, λ₂ . . . λ₁₋₁, λᵢ₊₁ . . . λₙ which pass through the device unaffected. The wavelength λᵢ is selected by a control signal, for example an electrical signal, applied to the device. The reconfigurable wavelength drop device also enables selecting among a large number of wavelength channels within a relatively short switching time. In a preferred embodiment, the re-configurable wavelength drop device enables selecting among in excess of a thousand wavelength channels in a switching time of less than or equal to 10 msec.

### BACKGROUND OF THE INVENTION

Today's optical communications network is divided into three separate segments: the long-haul, the metro network, and local area networks. The long haul portion of the network handles communication of large amounts of data between metropolitan areas. Typically, long-haul networks are point to point data transmission systems. The metro network distributes the data within a relatively small region such as a city. The metro network is typically a ring style or mesh style network providing multiple path redundancy for improved network reliability. The local area networks (LAN) are networks at the edge of the optical communications network and are typically restricted to buildings or campuses. Recent designs for optical networks require devices that permit a high level of intelligence in their management of data traffic. Recent network designs use multiple wavelengths and higher data rate optical signals to increase information bandwidth. Wavelength and dispersion management are critical issues in the efficient use of an optical network. Devices that are capable of selecting and combining an arbitrary wavelength with a data stream fulfill an important function in current networks, and their importance in future networks will increase. Also, as data rates increase, devices that can arbitrarily select a compensating amount of dispersion will fulfill an important function, particularly for signals that travel different paths such as in metro networks and in SONET (Synchronous Optical Network) ring networks.

A current approach to re-configurable intelligent wavelength routing in optical networks uses a tunable laser source and an arrayed waveguide grating (AWG) as a dense wavelength division multiplexer (DWDM.) AWGs are complex integrated optic devices that are difficult to fabricate reliably. Moreover, tunable lasers are an expensive light source and are unlikely to be the source of choice for applications in metro networks, where component cost is a critical consideration.

Fiber Bragg gratings are currently used as wavelength selective elements in passive and tunable optical systems. A Fiber Bragg grating (FBG) is an efficient, highly wavelength selective filter. An example of a FBG is a periodic refractive index variation in the core of an optical fiber, as shown schematically in FIG. 1. The periodic variation in index of refraction of a FBG reflects wavelengths in only a relatively narrow spectral window, typically spectral widths of less than 10 nm full width half max, as shown schematically in FIG. 2.

Typically an FBG is designed and fabricated as a fixed bandpass filter and is installed into a non-re-configurable optical network, thereby providing wavelength channels that are permanently provisioned in the network. “Network provisioning” is used to designate which wavelengths and which data paths are used to transmit data from location A to location B in a network. The provisioning or selection of wavelengths and data paths is determined by the amount of information being transmitted through the network. By themselves, fiber Bragg gratings are incapable of providing dynamic provisioning of wavelength channels. The center wavelength of fiber Bragg grating devices can be tuned over a limited range, typically less than nm. The tuning of the center wavelength of the FBG is done either by mechanical, thermal, magnetic or electrical actuation. However, in all cases the spectral range which can be covered by tuning FBGs is limited to less than a few tens of nanometers (<˜20 nm). These devices do not span the entire communication spectral band of typical optical fibers. In addition, the narrow continuous tuning range of FBGs is not ideally suited to the discreetly spaced wavelength channels defined by the International Telecommunication Union (ITU), on which multi-wavelength communication systems are based.

FBGs are also used to introduce dispersion into network systems to compensate for intrinsic system dispersion. By introducing a variable period or “chirp” along the length of the FBG, a wavelength dependent delay can be introduced in an optical data signal. As a result of the period variation in the grating, the reflection characteristic is also broadened, as shown in FIG. 3. The amount of dispersion afforded is fixed by the design of the FBG. High data rate optical signals are more susceptible to the deleterious effects of dispersion. In addition dispersion is fiber dependent and path length dependent in an optical communication system. In metro networks, where there are multiple possible paths for each data signal, reconfigurable dispersion compensation is needed because the high data rate signals in such systems experience different amounts of dispersion distortion depending on the path taken by the data. Currently, dynamically provisioned dispersion compensation systems are not available.

Microelectromechanical system (MEMS) actuated micro-mirrors offer an inexpensive, versatile way to redirect light beams in optical systems. MEMS technology permits the fabrication of micro-mirrors with dimensions on the order of 1 mm that are controllable by, for example, electrostatic, electromagnetic, piezoelectric, or thermal forces. Micro-mirrors may be readily formed into small to large arrays using a wide array of micromachining techniques, for example, silicon micromachining techniques. An example of one of the many prior art designs for micro-mirrors can be seen in FIGS. 4a and 4b, which show two views of a torsion hinged electrostatically actuated micro-mirror. The dashed arrows in FIG. 4b indicate rotation of the mirror about the axis of the hinge.

MEMS devices have been used in the prior art in combination with other devices as wavelength selective switches, an example of which is discussed in V. Aksuyk, B. Barber, C. R. Giles, R. Ruel, L. Stulz, and D. Bishop, “Low Insertion Loss Packaged and Fiber Connectorized MEMS Reflective Optical Switch,” Elect. Lett. Vol. 34, No. 14, July 1998, pp. 1413-1414. In this example, a micro-mirror array is combined with a free space bulk grating spectrograph to effect wavelength selection. A problem with this device and all others which rely on a free space mechanism for wavelength selection is a difficulty in maintaining the required alignment of the components within very narrow tolerances. The sensitivity of such devices to misalignment renders them susceptible to recurrent calibration problems.

### DESCRIPTION OF THE DRAWINGS

FIG. 1 shows a Fiber Bragg Grating optical fiber according to the prior art.

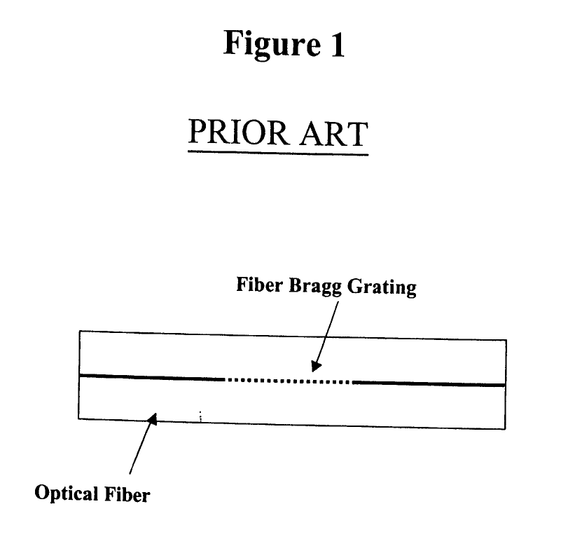

FIG. 2 shows the variation in index of refraction of a FBG optical fiber against wavelength.

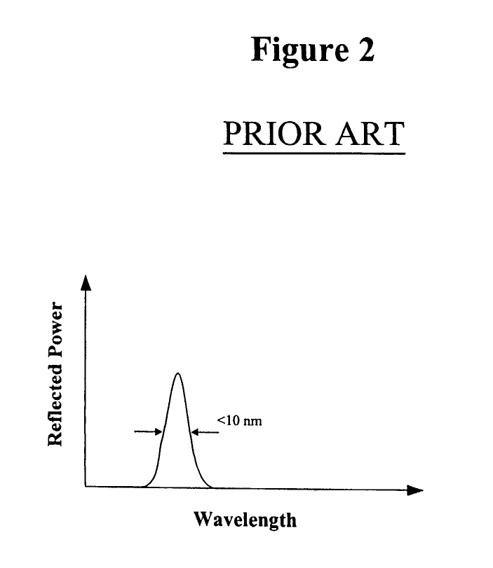

FIG. 3 shows how a wavelentgh dependent delay can be introduced in an optical data signal by introducing a variable period or “chirp” along the length of an FBG optical fiber.

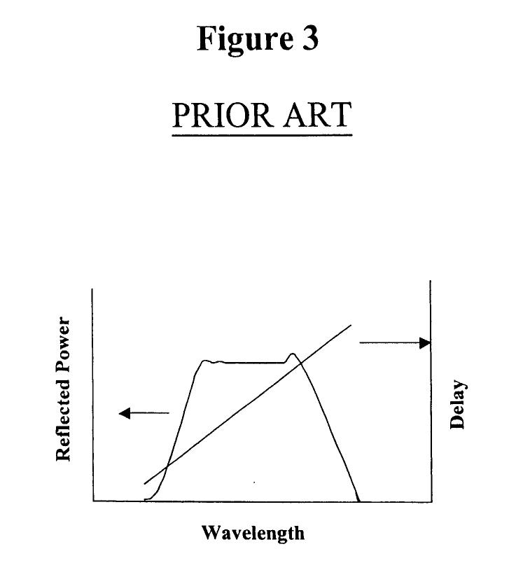

FIGS. 4a and 4b show prior art designs for micro-mirrors.

FIG. 5 is a schematic representation of a re-configurable wavelength selective device according to the invention.

FIG. 6 is a more detailed schematic representation of a re-configurable wavelength selective device according to the invention.

FIG. 7 shows a re-configurable wavelength selective device according to the invention, using a 1×N switch.

FIG. 8 shows another embodiment of a re-configurable selective device according to the invention.

FIG. 9 shows a re-configurable dispersion compensator according to the invention.

FIG. 10 shows the use of two-axis tilt micro-mirrors in connection with an embodiment of the invention.

### DETAILED DESCRIPTION OF THE INVENTION

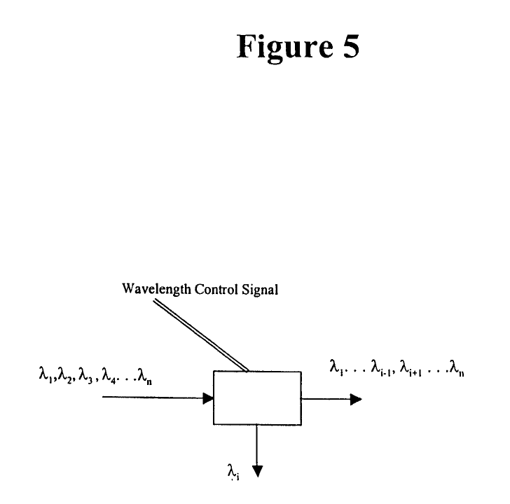

A re-configurable wavelength selective device according to the present invention, also referred to as a re-configurable wavelength drop device, is shown schematically in FIG. 5. The device has an input fiber, where a signal comprising multiple wavelengths λ₁,λ₂ . . . λₙ is brought into the device, and two output fibers, one for a selected wavelength λᵢ and the other for the remaining wavelengths λ₁,λ₂ . . . λᵢ₋₁,λᵢ₊₁ . . . λₙ which pass through the device unaffected. The wavelength λᵢ is selected by a control signal, for example an electrical signal, applied to the device. The reconfigurable wavelength drop device also enables selecting among a large number of wavelength channels within a relatively short switching time. In a preferred embodiment, the re-configurable wavelength drop device enables selecting among in excess of a thousand wavelength channels in a switching time of less than or equal to 10 msec.

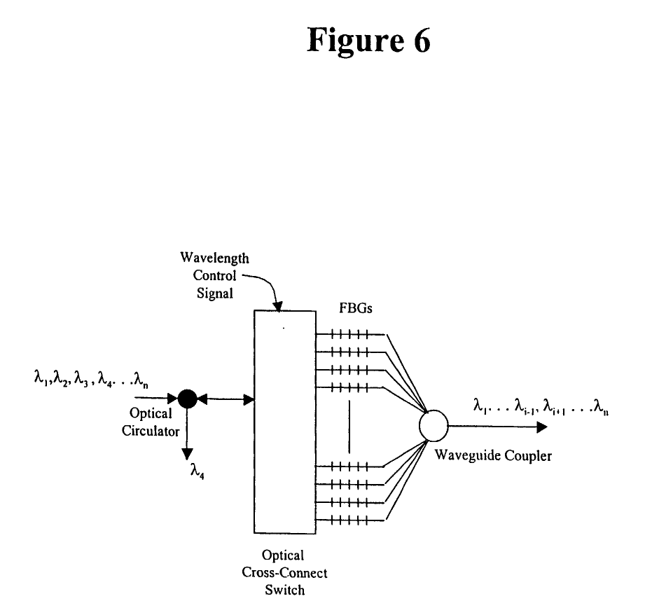

One embodiment of a re-configurable wavelength drop utilizes a MEMS cross-connect switch, an optical circulator, a fiber optic coupler, and number of fiber Bragg gratings, as shown in FIG. 6. The MEMS cross-connect switch comprises a number of input port fibers, at least one array of micro-mirror actuators, and an output array of fibers, wherein the optical signal is directed from any one of the input fibers to any one of the output fibers via the micro-mirror array. In the re-configurable wavelength drop of the present embodiment, the cross connect switch switches light from an input fiber to an output channel with the desired wavelength FBG. An optical circulator is a three port device in which light entering port #1 exits port #2, light entering port #2 exits port #3, and light entering port #3 exists port #1. In the re-configurable wavelength drop of the present embodiment, the optical circulator allows an input signal to enter the device while separating out the reflected signal from the FBG. The fiber optic coupler of the present embodiment combines all of the cross-connect switch output branches so that the unselected wavelength channels exit the re-configurable wavelength drop through a single fiber port. The FBGs are the wavelength selective elements which provide narrow band spectral filtering by retro-reflecting the Bragg wavelength.

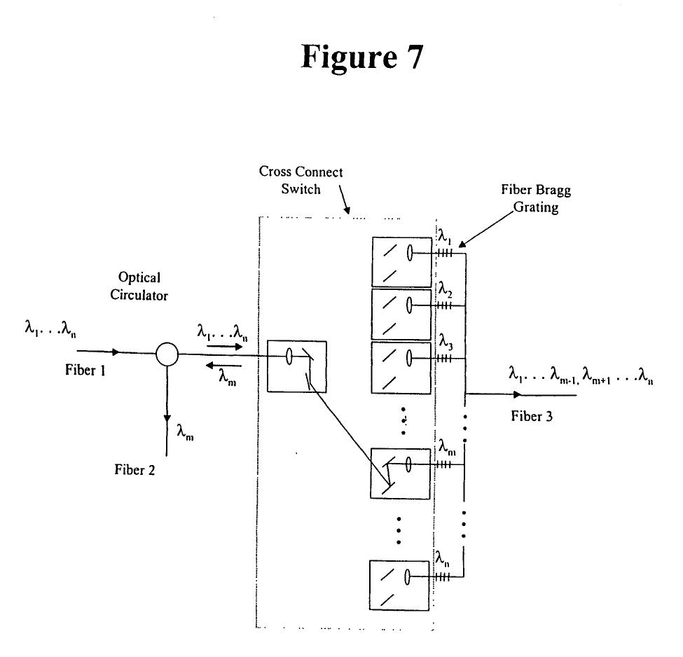

An exemplary embodiment of a re-configurable wavelength drop uses a 1×N switch as shown in FIG. 7. An input beam signal comprising multiple wavelengths λ₁,λ₂ . . . λₙ enters the device through fiber 1. The signal passes through an optical circulator and a cross-connect switch controlled by a wavelength control signal, for example an electrical signal. MEMS actuated mirrors in the cross connect switch direct the input beam to individual fiber Bragg gratings, each of which selects a wavelength corresponding to a prescribed ITU channel and reflects it. The FBGs are labeled according to the wavelength which each grating selects. Each FBG is a unique periodic refractive index variation within the core of an optical fiber. The period of the variation is determined by the desired wavelength for filtering each individual wavelength channel defined by the ITU grid. The selected wavelength λₘ reflects off of the fiber Bragg grating back in to the input fiber. In another embodiment, the filter Bragg grating may be replaced by an interference filter. The selected wavelength is then tapped off by an optical circulator into fiber 2. The non-selected wavelengths λ₁,λ₂ . . . λₘ₋₁,λₘ₊₁ . . . λₙ pass through the correspondingly labeled fiber Bragg gratings, are recombined by a fiber coupler, and exit through fiber 3.

In a preferred embodiment, the re-configurable wavelength drop device selects wavelengths for up to 256 ITU channels, which would cover the C and L optical bands with 50 GHz channel spacing. Electrically controlled MEMS micro-mirror actuators are configured as a 1×256 cross-connect switch using a pair of orthogonal single-axis mirror actuators of the type shown in FIG. 7. Embodiments of the invention are not, however, restricted to cross-connect switches using single-axis mirror actuators. For example, dual axis actuators could be used in place of single-axis actuators.

As will be apparent to those skilled in the art, the re-configurable wavelength drop device of the present invention is not susceptible to the calibration problems typical of prior art systems utilizing a free space wavelength selection mechanism.

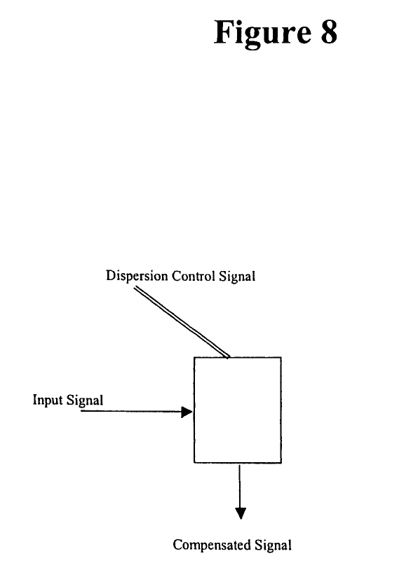

A re-configurable dispersion compensation device according to another embodiment of the present invention is shown schematically in FIG. 8. The device has an input fiber, where a corrupted signal enters the device, and an output fiber, where the dispersion-compensated signal exits the device. The appropriate level of dispersion is selected by a control signal, for example an electrical signal, applied to the device. The re-configurable dispersion compensating device enables selecting among a large number of different dispersion corrections depending on the path traveled by a data signal. In a preferred embodiment, the re-configurable dispersion compensating device enables selecting among in excess of a thousand different dispersion corrections.

The re-configurable dispersion compensator may be used, for example, to allow high data rate transmitters, such as OC-192 data rate standard, to be used in ring and mesh architecture networks, both of which show path dependent dispersion characteristics. In one embodiment, the re-configurable dispersion compensator utilizes a MEMS cross-connect switch, a circulator, and fiber Bragg gratings, each with a unique period variation or chirp along its length. The device has an input fiber, where the signal has been corrupted by intrinsic dispersion of the transmission line, and an output fiber, where the signal is compensated or corrected by a negative dispersion element. The device may be used, for example, to compensate for chromatic dispersion and polarization mode dispersion.

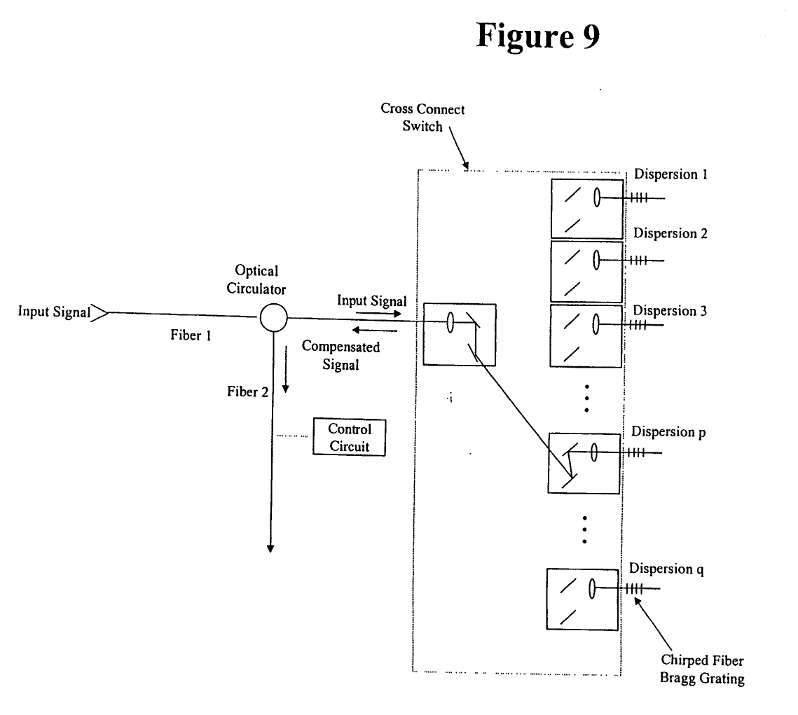

An embodiment of the re-configurable dispersion compensator is shown in FIG. 9. In this embodiment, an input beam signal enters the device through fiber 1 and passes through an optical circulator into a MEMS cross-connect switch, which directs the signal to the appropriate dispersion compensating grating (chirped FBG). The signal is then reflected off of the chirped fiber Bragg grating, imparting a compensating dispersion to the signal, thereby compensating the dispersion. The compensated signal passes back through the cross connect switch to the input fiber and is tapped off by the optical circulator to fiber 2. Each chirped Bragg grating has a different amount of dispersion, as suggested by the different labels on each chirped FBG. Typically, optical fibers have a positive dispersion in the wavelength region of interest, in which case the compensating dispersion imparted by the chirped FBG would be negative. However, in cases where a wavelength region of interest and/or optical fibers with a negative dispersion are used, the compensating dispersion imparted by the chirped FBG would be positive.

In another embodiment of the re-configurable dispersion compensator, a control loop may optionally be added to the device to create an automatic adjustment for dispersion depending on the input signal, as shown in FIG. 9.

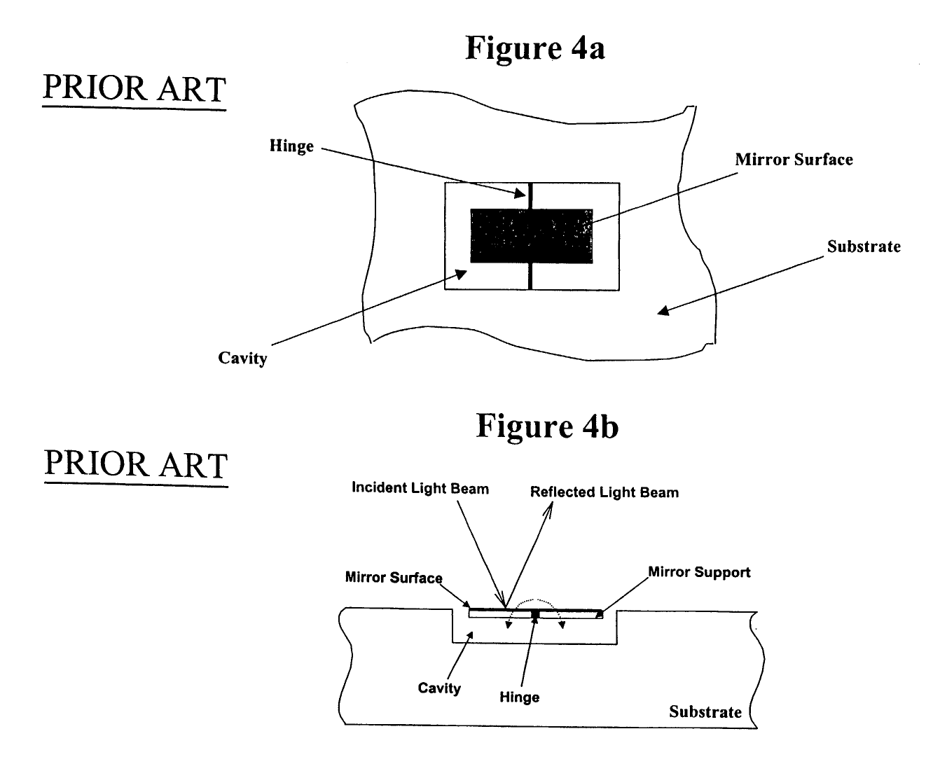

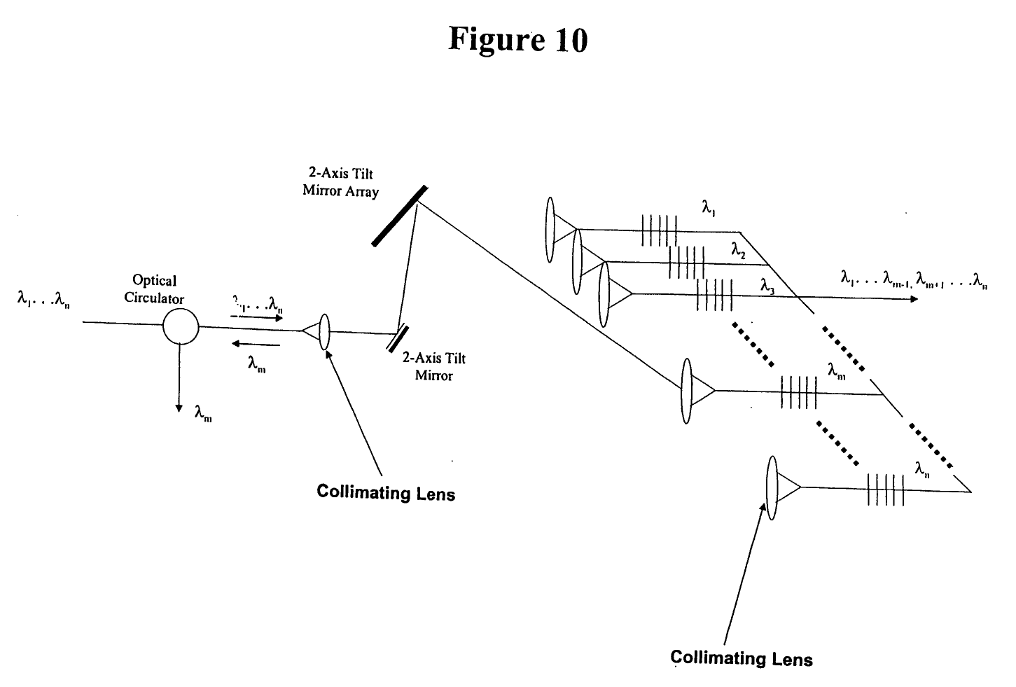

The embodiments shown in FIGS. 7 and 9 make use of single-axis MEMS actuated micro-mirrors, for example micro-mirrors of the type shown in FIGS. 4a and 4b. In other embodiments, two-axis tilt micro-mirrors may be used to build a re-configurable wavelength drop device or re-configurable dispersion compensator, for example a re-configurable wavelength drop as shown schematically in FIG. 10.

In another embodiment of the present invention, the wavelength selection function and the dispersion compensation function are combined to separate out and compensate an optical signal simultaneously. For example, a plurality of chirped FBGs having the desired spectral chirp for dispersion compensation may be used, wherein each of the chirped FBGs has a different medium wavelength corresponding to the center wavelength of a particular wavelength channel. In this way a desired amount of dispersion compensation may be added to a selected wavelength, and the selected dispersion-compensated wavelength exits the device separately from the non-selected wavelengths, which pass through the device unaffected.

Various embodiments of the present invention have now been described. While these embodiments have been set forth by way of example, various other embodiments and modifications will be apparent to those skilled in the art. In particular, while the present disclosure has discussed primarily embodiments including MEMS micro-mirrors and actuators, it will be apparent to those skilled in the art that the present invention is not limited to such structures, but may include, for example, any functional multi-port switch, including arrays of macroscopic mirrors and actuators.

I claim:

1. A re-configurable wavelength selective device comprising:
an input fiber, where a signal comprising multiple wavelengths λ₁,λ₂ . . . λₙ is brought into the device, and
two output fibers, one for a selected wavelength λ₁ and the other for the remaining wavelengths λ₁,λ₂ . . . λ₁₋₁,λᵢ₊₁ . . . λₙ which pass through the device unaffected;
wherein the wavelength λᵢ is selected by a control signal applied to the device.

2. A re-configurable wavelength selective device comprising:
a MEMS cross-connect switch, comprising a plurality of input port fibers, at least one array of micro-mirror actuators, and an array of output fibers, said cross-connect switch configured so that an optical signal received from any one of the input fibers may be directed to any one of the output fibers via the micro-mirror array;
an optical circulator having a first port, a second port and a third port, wherein light entering the first port exits the second port, light entering the second port exits the third port, and light entering the third port exists the first port.
a fiber optic coupler configured to combine all of the cross-connect switch output branches so that unselected wavelength channels exit the re-configurable wavelength drop through a single fiber port, and
a plurality of fiber Bragg gratings (FBGs) configured to provide narrow band spectral filtering by retro-reflecting the Bragg wavelength.
